(19) United States
(12) Patent Application Publication
(10) Pub. No.: US 2025/0164151 A1
(43) Pub. Date: May 22, 2025

(54) APPARATUS AND SYSTEM FOR GENERATING THERMAL ENERGY USING CONCENTRATED SOLAR POWER

(71) Applicant: Mustapha HAMDAN, London (GB)

(72) Inventor: Mustapha HAMDAN, London (GB)

(21) Appl. No.: 18/840,021

(22) PCT Filed: May 2, 2023
(86) PCT No.: PCT/GB2023/051156

§ 371 Date: Aug. 20, 2024

(30) Foreign Application Priority Data
Mar. 1, 2022 (GB) 2202779.1

(51) Int. Cl. F24S 20/20; F24S 23/30; F24S 23/71; F24S 60/00; F24S 80/20; F28D 13/00

(52) U.S. Cl. CPC F24S 20/20; F24S 60/00; F24S 80/20; F28D 13/00; F24S 23/31; F24S 23/71

(57) ABSTRACT

Apparatus for generating thermal energy using concentrated solar power, the apparatus comprising a fluidised bed which including a dual heat exchange and solar receiver and means to circulate solid particles around the fluidised bed.

The present invention relates to an apparatus and system for generating thermal energy using concentrated solar power. More especially, the invention relates to apparatus in the form of a combined heat exchanger and solar receiver to provide a more efficient concentrated solar power technology at reduced levelised cost of energy.

### BACKGROUND TO THE INVENTION

Water and energy are inseparably entwined, since large amounts of energy are required to desalinate, treat, pump, transport, cool, heat and recycle water. The water-energy nexus is highlighted as two of the seventeen United Nations Sustainable Development Goals 2016-“affordable and clean energy” and “clean water and sanitisation”.

In the particular case of the Gulf region, the GCC countries have one of the highest carbon dioxide emissions per capita in the world. This is due to the GCC's heavy reliance on fossil fuels, along with rapid urbanization, high population growth, and rather limited water resources with 80-90% of fresh water being produced by desalination alone. These countries air-cooling and water needs account for 60-70% of their electricity consumption. Thus, finding a solution to address the water-energy nexus is vital to achieving a sustainable society.

Maintaining such an energy-intensive culture from non-renewable sources is unsustainable. With the switch to renewable energies being crucial to the region's long-term sustainable development, public bodies and academic institutions have invested heavily on solar energy.

Concentrated solar power is a promising energy capture technology that uses optical devices to concentrate the power of the sun on to a surface and in turn generates power by means of a thermal-to-electric conversion unit. Solar energy is the most abundant source of power on earth for free and it should be in our interest to capture this energy.

Each year 885 million TWh of solar power reaches the earth surface, however, less than 0.002% of primary energy is consumed by humans.

The International Energy Agency suggests that approximately 11.3% of the global electricity demand could be met by concentrated solar power by 2050. However, the U.S. Department of Energy released a target for concentrated solar power cycles to be more than 50% efficient by 2030 to reduce the levelized cost of energy to 5¢/kWh.

Direct solar radiation is of interest to concentrated solar power systems, the rays of the sun come in a straight line and are not scattered or reflected. Direct normal irradiance is used to identify the amount of solar power received by a surface, such as a mirror in concentrated solar power systems. Direct normal irradiance has units of kWh/m² of a surface held perpendicular to the direct radiation from the sun.

One of the main aspects in identifying the right location of a concentrated solar power plant is to find out the direct normal irradiance value in that part of the world as this will affect the potential to generate power. Direct normal irradiance values are affected by weather conditions as clear skies and dirt-free reflector mirrors are needed to capture and concentrate the sun radiation effectively.

Concentrated solar power technology which integrates thermal energy storage materials is seen as the way forward to solving the current problem of solar energy discontinuity. Thermal energy storage materials have the ability to store heat and thus enable power production in the absence of sunlight, at night or in poor weather conditions.

The current thermal energy storage material used to store energy is a binary molten salt mixture of 60 wt % NaNO₃ 40 wt % KNO₃ (solar salt) which can currently store energy for up to 15 hours. However, molten salts present a significant problem in that their use results in a high levelised cost of energy.

The use of molten salts as thermal energy storage materials carry's with-it high maintenance and operation costs due to a number of reasons: 1) highly corrosive and thus requiring expensive containment materials; 2) molten salt must be kept heated at approximately 200° C. to prevent freezing, thus, solidifying in pipes; 3) high viscosity has a negative impact of pump performance adding to levelised cost of energy. Molten salts are also costly materials and have an outlet receiver temperature below 600° C. which limits the thermal-to-electric efficiency of the power cycle.

To overcome the current limitations of concentrated solar power technologies, it is necessary to select an alternative thermal energy storage material as well as a new receiver design improving levelised cost of energy and profitability of these plants. A range of thermal energy storage materials, both in terms of sensible and sensible/latent energy storage, have been studied and developed so far other than molten salts, such as oil-based fluids, solid particles and phase change materials among others.

Current concentrated solar power plants employ the conventional receiver technology that use gas or liquid continuous phase thermal energy storage or heat transfer fluids which flow through pipes. However, the temperature limitation, corrosive nature and costly maintenance of conventional thermal energy storage materials have resulted in high levelised cost of energy.

The prior art discloses a number of solar plants utilising fluidised beds. For example CN209326118U, US2014/311479 and U.S. Pat. No. 4,338,919. In each case though the assemblies have separate distinct units for fluidisation, solar heating and storage. As such the assemblies to be complex and expensive.

WO2014/038553 discloses a combined fluidised bed solar receiver but does not provide continuous movement of solid particles through the assembly.

The present invention provides a combined compact unit providing a dual solar receiver and heat exchanger to provide continual movement of solid particles past the solar receiver. Statements of invention

According to a first aspect there is provided a thermal energy generation apparatus, the apparatus comprising a fluidised bed which including a solar receiver and means to circulate solid particles around said solar receiver.

Preferably, the apparatus has a unitary construction and provides a combined solar receiver and gas or solid particle transportation assembly.

Thermal energy generation apparatus, the apparatus comprising a unitary structure including a fluidised bed and solar energy receiver and means to continuously transport solid particles past said solar energy harvesting unit.

Preferably the apparatus that continuously transports and recirculates solid particles past the solar receiver.

Preferably, the fluidised bed is constructed by hollow baffles along the height of the bed.

Preferably, the solid particles have thermal storage properties. Preferably still, the solid particles are desert sand.

Preferably, the fluidised bed further includes a heat exchanger. Preferably or additionally the solar receiver includes a heat exchanger.

Preferably, the baffles of the heat exchanger are housed within an enclosure unit that forms a second heat exchanger within the fluidised bed.

Preferably, the baffle enclosure includes side walls that extend to an aperture in each centre to provide an inlet or outlet on either side of the unit to allow micro or nano particles can pass through the heat exchanger baffles.

Preferably, a base of the unit is apertured to provide the cold gas inlet into the heat exchanger.

Preferably, the apparatus further comprises at least one storage tank to store solid particles that have been heated or cooled after passing through the baffle enclosure unit.

Preferably, the apparatus further comprises at least one storage tank to store fluid with thermal properties that has been heated or cooled after passing through the baffle enclosure unit.

Preferably, the heat exchanger is formed from two baffled sections, connected together at their base.

Preferably the apparatus comprises a fluidised bed with a hollow baffle arrangement to create channels which separate the thermal energy storage material towards two solar receivers to continuously circulate the solid thermal energy storage material.

Preferably, each baffled section has a rounded hollow baffle section at its distal end which extends outwardly to a respective solar receiver.

Preferably, a hot gas outlet is provided at the top surface of the or each solar receiver.

Preferably, the apparatus further comprises at least one heliostats located adjacent or opposite an external wall of the or each solar receiver.

Preferably, an elliptical mirror or fresnel lens is located above the solar receiver to reflect heat downwardly to the receiver.

### BRIEF DESCRIPTION OF DRAWINGS

Embodiments of the invention will be described by way of non-limiting examples and with reference to the accompanying drawings in which:

FIG. 1 is a flow diagram illustrating one embodiment of a system according to the invention;

FIGS. 2A to 2C show a combined heat exchanger and solar receiver assembly constructed in accordance with the invention;

FIGS. 3A and 3B show perspective and side sectional views of the heat exchanger and receiver of FIG. 2 (A to C), showing the baffle arrangement;

FIGS. 4A and 4B show a baffle enclosure unit constructed in accordance with the invention;

FIG. 5 show the direction of particle flow through the baffle enclosure unit between storage tanks;

FIG. 6 illustrates a combined double heat exchanger solar receiver, showing the primary heat exchanger, secondary heat exchanger and solar receiver;

FIG. 7 shows a dual receiver/heat exchanger and a circulating fluidized bed constructed in accordance with a further embodiment of the invention; and

FIG. 8 illustrates an alternative combined circulating fluidised bed heat exchanger and solar receiver constricted or constructed? in accordance with the invention

FIG. 9 illustrates an alternative combined circulating fluidised bed heat exchanger and solar receiver constructed in accordance with the invention.

### DETAILED DESCRIPTION OF PREFERRED EMBODIMENTS

The focus of the present invention is the arrangement of the design and the process of continuously circulating solid particle thermal energy storage materials in a combined double heat exchanger and solar receiver design to produce thermal energy using concentrated solar power in turn producing electricity by means of a thermal-to-electric conversion power cycle.

The design and process is arranged to continuously heat the thermal energy storage material and exchange the stored heat to the gas (heat transfer fluid) by concentrated solar power, using gas to recirculate the solid particles. The energy absorbed by the heat transfer fluid from the thermal energy storage material is then directed to the power block to produce electricity.

The design has two separate compartments in the heat exchanger section (so to form a double heat exchanger). In this way the heat exchanger can use two different thermal energy storage materials in separate compartments to provide additional thermal energy storage, be it stationary or flowing in and out into tanks.

The first compartment of the heat exchanger is arranged to provide the main circulation of solid particles flow to the receiver (the primary heat exchanger).

The secondary heat exchanger compartment is formed with hollow baffles where micro or nano particles of phase change materials (PCMs) are able to flow in and out, in to cold and hot tanks for thermal storage. The baffles are housed within an enclosure unit that provides a flow path of the micro/nano particles through all the baffles.

The baffle enclosure unit is arranged to provide a secondary heat exchange. During this process heat is exchanged from the walls of the main heat exchanger section to the micro/nano particles. Thus, when heat is required in the absence of sunlight, hot micro/nano particles will flow into the secondary heat exchanger to heat up the primary heat exchanger. It is also possible to use water in the secondary compartment to generate steam for additional electricity production. It is also possible to insert a heat exchanger in the hot storage tank to heat water to produce steam and in turn be used to power a turbine to produce electricity.

The design allows for high gas phase velocities compared to minimum fluidisation velocities of the solid particles, leading to an increase of the heat transfer rates and power generation. In addition, the design reduces the need of higher inlet gas velocity that would be required to circulate the solid particles, this reduces the gas cooling effect on the thermal energy storage material.

The present invention utilises a circulating fluidised bed as the concentrated solar power primary heat exchanger, and a solar receiver where the thermal energy storage material continuously circulates through to heat up.

Substantial research experimentation has identified desert sand a preferred thermal energy storage material in the primary heat exchanger due to its thermal conductivity, abundance, size, cost and high temperature stability.

Desert sand as a particulate material offers high interface area, combined with its capability to withstand temperatures of up to 1000° C. without undergoing agglomeration and subsequent degradation, and makes it a preferred material to be used in thermal systems. Moreover, desert sand is highly abundant in GCC countries and has suitable thermal properties, which add to its potential as a heat storage medium.

The embodiments of the present invention seek to improve the current performance of concentrated solar power technologies and reduce the levelised cost of energy for such systems.

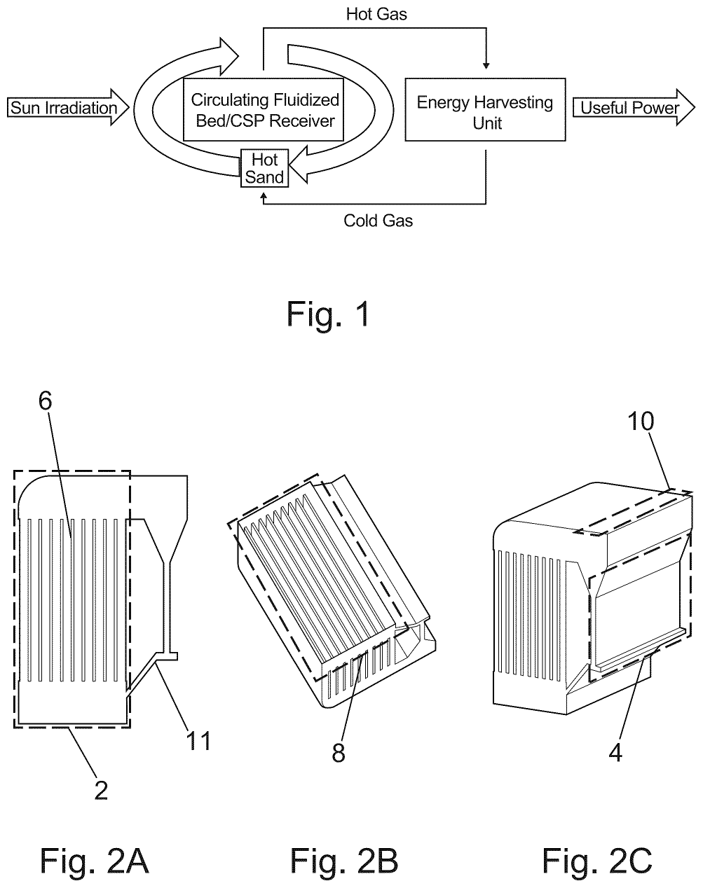

FIG. 1 is a flow diagram showing the general principles of the circulating fluidised bed system of the invention.

The design allows for an internal pneumatic transport of the sand within a compact system containing a circulating fluidised bed as the primary heat exchanger, a fluidised bed as the secondary heat exchanger in a baffle enclosure section and a solar receiver, all in one unit.

The design provides for higher mass flow rates compared to a normal fluidised bed, high uniform outlet temperatures, and minimised hot spots in the sand bed. These all contribute to an increase in heat transfer from thermal energy storage material to the heat transfer fluid. The increase in heat transfer performance directly increases the electricity produced in the power cycle.

The system consists of a circulating fluidised bed without the need of auxiliary mechanical equipment to circulate the thermal energy storage material to the solar receiver. The thermal energy storage media (for example, desert sand) stores the energy from the sun gathered by means of the concentrated solar power receiver. The heat exchange between the particulate material and the working fluid (air, carbon dioxide or other gases) would take place in the circulating fluidised bed, which constitutes the numerical domain in the simulations. Finally, the energy stored in the heat transfer fluid would be used to produce power in the energy harvesting unit.

The present invention provides a circulating fluidised bed as the primary heat exchanger between the thermal energy storage material (desert sand) and the gas (heat transfer fluid). The fluidised bed baffle enclosure unit as the heat exchanger between the walls of primary heat exchanger and the micro/nano phase changing material, and a solar receiver to reheat the sand.

FIG. 2 shows a dual heat exchanger/solar receiver assembly constructed in accordance with the invention. FIG. 2A is a side view of the assembly, FIG. 2B is a view of the underside of the assembly and FIG. 2C is a side perspective view.

The assembly comprises a heat exchanger section 2 and a solar receiver section 4 constructed as a single unit and which provides the fluidised bed.

The heat exchanger section 2 comprises an array of hollow baffles 6. As can be seen in FIG. 2B the base 8 of the heat exchanger section 2 is baffled so to provide a cold gas inlet. The top edge 10 of unit above the solar receiver section 4 of the assembly provides a gas outlet.

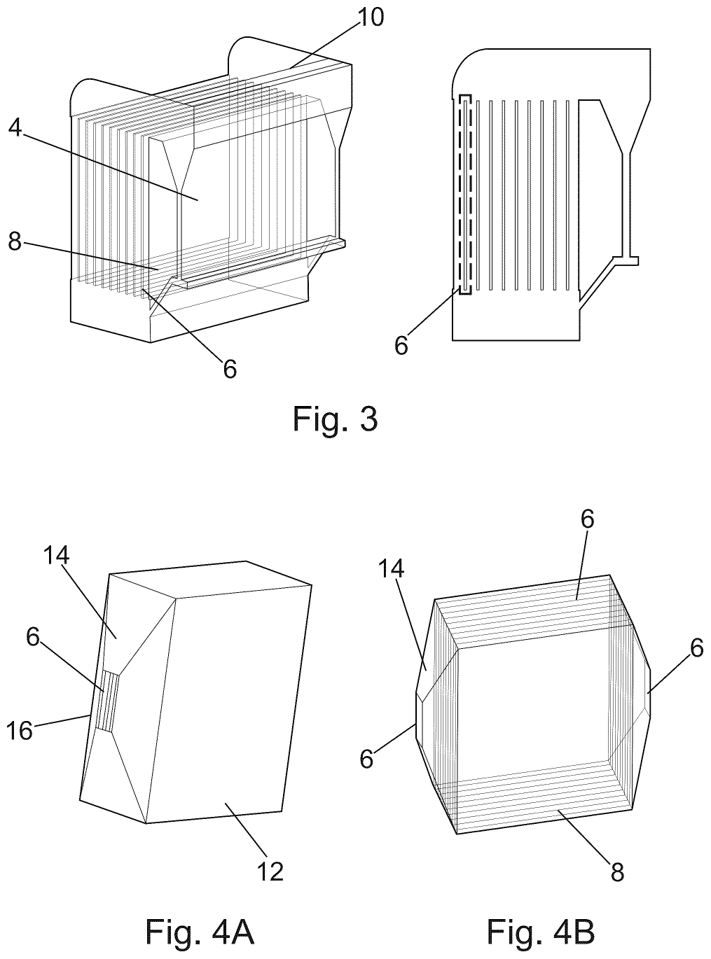

FIG. 3 shows a sectional view of the heat exchanger 2 and solar receiver 4 showing the arrangement of hollow baffles 6.

The inclusion of baffles 6 improves the heat transfer performance by providing heat turbulence between the two phases as well as preventing stagnant sections of the sand bed.

In addition, the use of hollow baffles 6 allows for an additional thermal energy storage material to enter without affecting the flow of the thermal energy storage material inside the primary fluidised bed section.

The use of thermal energy storage materials in the baffles 6 allows for extra heat storage, be it stationary or flowing in and out into storage tanks. The extra heat from the thermal energy storage materials obtained from the baffles 6 allows for heat transfer back to the thermal energy storage material in the fluidised bed for use in the absence of solar energy, for example in poor weather conditions or at night.

The additional material inside the baffles 6 could also be water which will would then turn into steam to generate electricity in a power cycle.

The resulting reduction in the diameter in the fluidised bed and design of the baffles allows the sand to move up higher in the required direction passing by the solar receiver, following the continuity equation:

$${A}_{1} {V}_{1} = {A}_{2} {V}_{2}$$

The baffles 6 also minimise the size of bubbles in the bed, making it more homogeneous. The bubbles are limited to slugs in the channels rather than large bubbles which may otherwise form, increasing heat transfer.

While circulating fluidised beds may require higher velocities to allow for the sand to circulate round, design of the present invention incorporates a solution to minimise the pumping pressure costs of the increased velocity required and also minimise thermal energy storage material cooling from higher gas velocities. To do this, the system is based on continuity equation.

Rearrangement of the continuity equation establishes that a decrease in cross-sectional area increases the fluids velocity. Therefore, to allow the sand particles to circulate without increasing the inlet velocity, the fluidised bed must have a smaller diameter compared to the gas inlet diameter. Thus, the use of spaced apart hollow baffles 6 reduces the total internal cross-sectional area of the bed.

The design also includes a loop seal 11 that has two functions—to control the flow of sand back to the fluidised bed from the solar receiver as well as increasing the residence time of sand in the solar receiver.

FIG. 4A illustrates a baffle enclosure unit 12 constructed in accordance with the invention. The unit 12 wraps around the baffle section 6 of the assembly and acts as a secondary heat exchanger for micro/nanoparticles. The unit 12 is generally rectangular box-shaped with each side wall having outwardly angled panels sections 14 extending to apertures 16 in the centre of each side wall which provide an inlet/outlet for micro/nano particles on either side of the unit 12. The base of the unit 14 is aperture to provide the hot gas inlet 8 into the primary heat exchanger.

FIG. 4B is a sectional view of the unit 12 showing the baffle arrangement 6 of the first heat exchanger within the unit 12.

Literature has proven the advantageous use of micro/nano solid particle phase change materials to produce higher heart transfer rates mainly due to the larger interaction area it can provide and its high energy to weight ratio. However, the size and weight of the particles makes it impossible to fluidise using high gas mass flow rates.?

However, as previously detailed, higher mass flow rates leads to an increase in power production. The baffle enclosure unit 12 of the present invention achieves the use of fluidised micro/nano particles in concentrated solar power systems by allowing micro/nano particle phase change materials to flow past the hot walls of the primary heat exchanger unit and heat up. The heated micro/nano particles can then be stored before subsequently flowing back into the baffle enclosure unit 12 to heat up the primary heat exchanger walls. The primary heat exchanger will then heat up the primary thermal energy storage material and exchange the heat to the gas phase. This process allows electricity production in the absence of sunlight or poor weather conditions and reduce the size of thermal energy storage material storage tanks of current concentrated solar power systems.

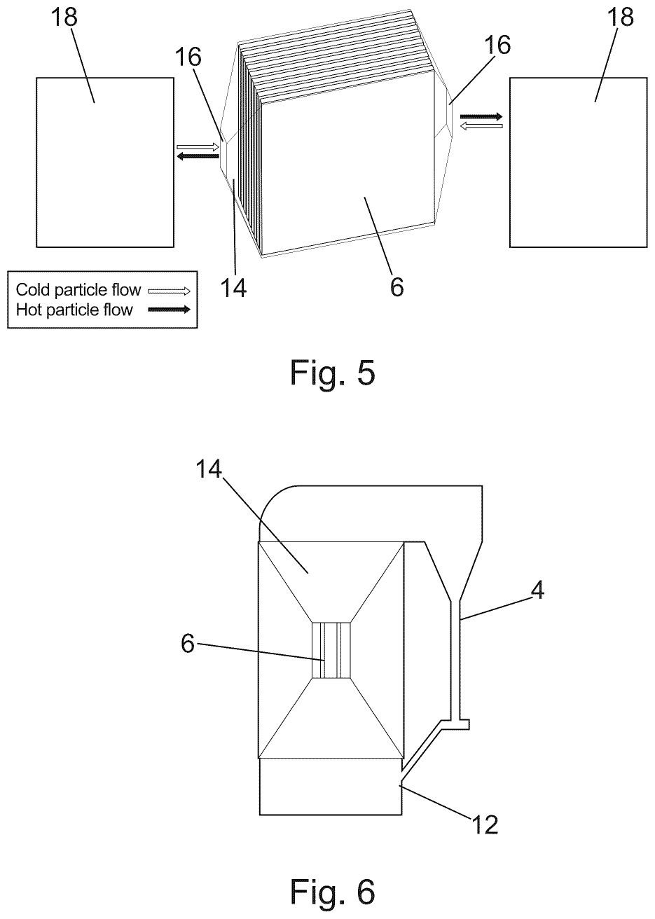

FIG. 5 shows direction of hot and cold particle flow through the baffles 6 of the primary heat exchanger between hot/cold storage tanks 18. The particles are pumped into the baffle enclosure unit 10 where they absorb/release heat until the desired temperature is reached. Once the desired temperature is achieved, the particles are stored in the tanks 18 for use in the absence of sunlight or in poor weather conditions.

FIG. 6 shows a baffle enclosure unit 12 incorporated into a combined heat exchanger 6 and solar receiver 4 assembly. The resulting system combines first and second heat exchangers (baffle assembly 6, and the baffle enclosure unit 12 respectively) with a solar receiver 4.

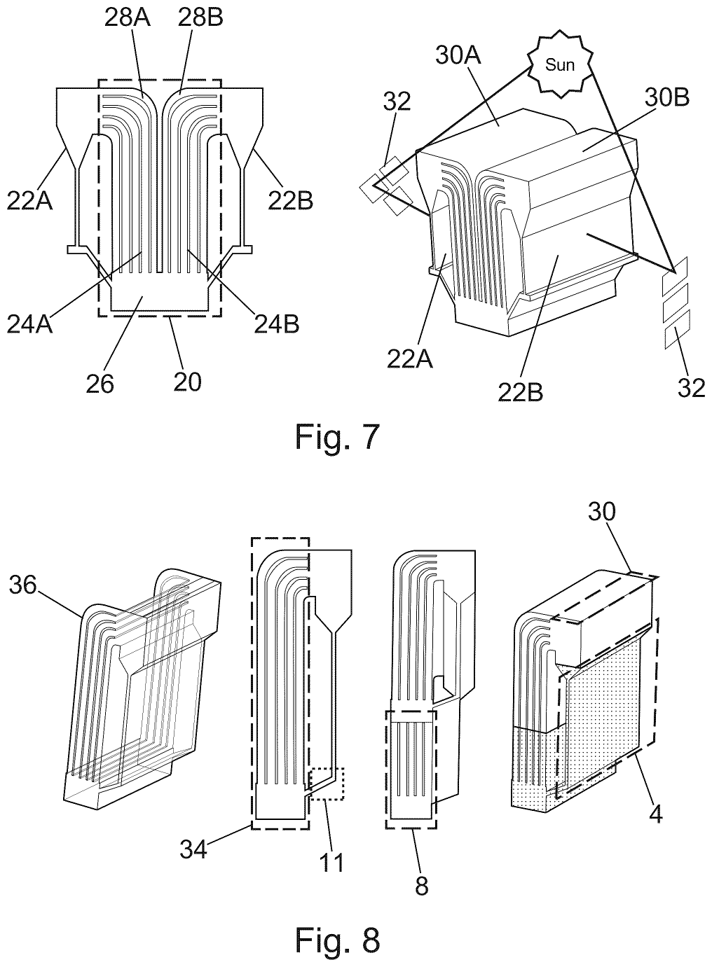

FIG. 7 shows an alternative assembly comprising a heat exchanger 20 with dual solar receivers 22 extending from each side of the heat exchanger 20. The heat exchanger 20 is formed from two baffled sections 24A, 24B connected together at their base 26. As described previously the base 26 is baffled to provide a cold gas inlet 28.

Each baffled section 24A, 24B has a rounded hollow baffle section 28A, 28B at its distal end which extends outwardly to a respective solar receiver 22A, 26B. A hot gas outlet 30A, 30B is provided in the top surface of each solar receiver 22A, 22B.

Heliostats 32 may be located adjacent or opposite the external wall of one or each solar receiver 22 to reflect sun rays back towards and onto the receiver 22.

FIG. 8 illustrates a further alternative embodiment of a combined circulating fluidised bed heat exchanger and solar receiver incorporating a single heat exchanger 34 with a hollow baffle plates 6 with rounded sections 36 at the top to provide a more precise flow of solid particles to the solar receiver.

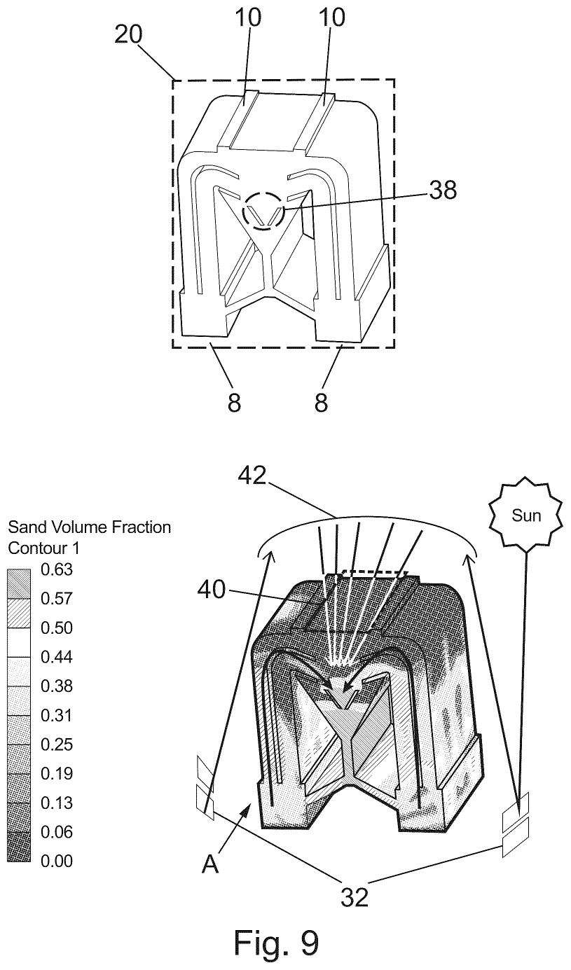

FIG. 9 Illustrates an alternative conceptual design of a novel combined circulating fluidised bed heat exchanger and solar receiver, where the solar receiver is situated near the centre of the device. The solar receiver, receives concentrated solar power through the transparent window above, heating up the solid particles as they continuously circulate by and simultaneously exchanging heat to the gas.

1. Thermal energy generation apparatus, the apparatus comprising a compact unitary structure including a fluidised bed and a solar receiver and means to continually circulate solid particles around said solar receiver.

2. Apparatus according to claim 1, wherein the solid particles are desert sand.

3. Apparatus according to claim 1, wherein the fluidised bed further includes a heat exchanger.

4. Apparatus according to claim 3, wherein the solar receiver and heat exchanger form a unitary structure.

5. Apparatus according to claim 3, wherein the heat exchanger comprises an array of hollow baffles.

6. Apparatus according to claim 5, where in the baffles of the heat exchanger are housed within an enclosure unit that forms a second heat exchanger within the fluidised bed.

7. Apparatus according to claim 6, where in the baffle enclosure includes side walls that extend to an aperture in each centre to provide an inlet or outlet on either side of the unit to allow micro or nano particles can pass through the heat exchanger baffles.

8. Apparatus according to claim 6, wherein in a base of the unit is apertured to provide the cold gas inlet into the heat exchanger.

9. Apparatus according to claim 6, wherein the apparatus further comprises at least one storage tank to store solid particles that have been heated or cooled after passing through the baffle enclosure unit.

10. Apparatus according to claim 3, wherein the heat exchanger is formed from two baffled sections, connected together at their base.

11. Apparatus according to claim 10, wherein each baffled section has a rounded hollow baffle section at its distal end which extends outwardly to a respective solar receiver.

12. Apparatus according to claim 1, wherein a hot gas outlet is provided at the top surface of the or each solar receiver.

13. Apparatus according to claim 12, wherein the apparatus further comprises at least one heliostats located adjacent or opposite an external wall of the or each solar receiver.

14. Apparatus according to claim 13, wherein an elliptical mirror or fresnel lens is located above the solar receiver to reflect heat downwardly to the receiver.
